(19) United States
(12) Patent Application Publication
(10) Pub. No.: US 2017/0299107 A1
(43) Pub. Date: Oct. 19, 2017

(54) PIPELINE STRAINER FOR REDUCING ENTRAINED GAS AND DEBRIS

(71) Applicant: The Metraflex Company, Chicago, IL (US)

(72) Inventors: James R. Richter, Lincolnshire, IL (US); Martin I. Rogin, Libertyville, IL (US)

(21) Appl. No.: 15/130,369

(22) Filed: Apr. 15, 2016

(51) Int. Cl. F16L 55/24; B01D 36/00; B01D 35/02

(52) U.S. Cl. CPC F16L 55/24; B01D 35/02; B01D 36/001

(57) ABSTRACT

A pipeline strainer having a body with a straining element therein. An air release valve may be disposed in the body so that any accumulated entrained gas may be vented. A baffle may be disposed downstream of the straining element and used to accumulate entrained gas in an eddy. The baffle may include or comprise a coalescing material. The pipeline strainer may have a Y-shaped body or may comprise a basket strainer.

### FIELD OF THE INVENTION

The present invention relates to a pipeline strainer which includes a baffle, an air release valve, or both, to allow for entrained gas to be removed from the liquids being passed through the pipeline strainer.

### BACKGROUND OF THE INVENTION

Pipeline strainers are used for protecting pumps, compressors, turbines, meters, automatic valves, sprinkler heads, nozzles, steam traps, heat exchangers, meters, and other pipeline equipment. The pipeline strainer mechanically removes solids from a flowing fluid with a perforated, mesh, or wedge wire straining element. The solids are retained in the straining element, allowing the fluids to flow therethrough and passed to the downstream equipment. After a certain period of time, a drain in the pipeline strainer can be opened to remove the debris in order to avoid excess pressure drop associated with the collection of solids in the straining element.

Two common designs for pipeline strainers are the Y-shaped pipeline strainers (see, e.g., FIG. 3 of U.S. Pat. No. 5,718,822) and the basket pipeline strainer (see, e.g., FIG. 4 of U.S. Pat. No. 5,718,822). Most basket pipeline strainers are intended for horizontal or slightly inclined piping. On the other hand, the Y-shaped pipeline strainers, as well as some T shaped basket strainers, can be used in horizontal, as well as vertical (downward), piping. In the Y-shaped pipeline strainers, a debris collection chamber, which houses the straining element, is disposed obliquely to the flow path of the fluid thorough the pipeline strainer.

Oftentimes, liquids that are passed through the pipeline strainer include entrained gas (such as air). In some configurations in may be necessary to remove as much of the entrained gas as possible to avoid damaging downstream equipment, while in other configurations it may merely be desirable to remove the entrained gas.

Therefore, it would be desirable to provide a pipeline strainer that allows for entrained gas to be collected and/or vented to the atmosphere. It would also be desirable if such a pipeline strainer provided such a feature without needlessly increasing the pressure drop of the liquids passing through the pipeline strainer.

### SUMMARY OF THE INVENTION

A new pipeline strainer has been invented which includes an air release valve, a baffle, or both. The air release valve can be used to vent entrained gas that have accumulated. Additionally, the baffle can be used to create an eddy, or low pressure area, in which entrained gas may accumulate. The accumulated gas can be vented if an air release valve is provided. Thus, the baffle allows the entrained gas to accumulate, while the air release valve allows entrained gas to be vented. Either of these are believed to reduce the amount of entrained gas that is passed to the equipment downstream of the pipeline strainer. These and other benefits will be appreciated in the following summary and detailed description.

According to a first aspect of the present invention, the present invention provides a pipeline strainer comprising a body and a straining element. The body comprises an inlet for a fluid, an outlet for the fluid, an aperture extending through the body, a debris drain, a cavity inside of the body connecting the inlet and the outlet and being defined at least in part by an inner surface, and an air release valve disposed in the aperture of the body. The straining element is disposed in the cavity and includes a first end and a second end opposite the first end. The first end of the straining element is disposed proximate the inlet of the body.

In one or more embodiments of a pipeline strainer according to the various aspects of the present invention, the pipeline strainer further comprises a baffle extending away from the inner surface into the cavity of the body, wherein the baffle is disposed between the inlet and the outlet. The baffle may include an upstream surface and a downstream surface, and the downstream surface may be disposed proximate the aperture. The downstream surface may comprise a coalescing material. The baffle may have a linear shape in a side profile view. The baffle may have a curvilinear shape in a side profile view. The baffle may extend away from the inner surface into the cavity of the body in a direction towards the outlet of the body. The baffle may extend away from the inner surface into the cavity of the body in a direction towards the inlet of the body.

In one or more embodiments of a pipeline strainer according to the various aspects of the present invention, the second end of the straining element may be disposed proximate the debris drain.

According to a second aspect of the present invention, the present invention provides a pipeline strainer comprising a body and a straining element. The body comprises an inlet for a fluid, an outlet for the fluid, a cavity inside of the body defined at least in part by an inner surface and connecting the inlet and the outlet, a debris drain, and a baffle extending away from the inner surface into the cavity of the body. The straining element is disposed in the cavity and includes a first end and a second end opposite the first end. The first end of the straining element is disposed proximate the inlet of the body. The baffle includes an upstream surface and a downstream surface, and the upstream surface is disposed between the first end of the straining element and the outlet.

In one or more embodiments of a pipeline strainer according to the various aspects of the present invention, the downstream surface of the baffle comprises a coalescing material.

In one or more embodiments of a pipeline strainer according to the various aspects of the present invention, the baffle extends away from the inner surface into the cavity of the body in a direction towards the outlet of the body.

In one or more embodiments of a pipeline strainer according to the various aspects of the present invention, the baffle extends away from the inner surface into the cavity of the body in a direction towards the inlet of the body.

In one or more embodiments of a pipeline strainer according to the various aspects of the present invention, the baffle has a curvilinear shape in a side profile view.

In one or more embodiments of a pipeline strainer according to the various aspects of the present invention, the baffle has a linear shape in a side profile view.

In one or more embodiments of a pipeline strainer according to the various aspects of the present invention, the pipeline strainer further comprises comprising an air release valve disposed in the body between the baffle and the outlet and configured to allow gas to be vented from the cavity of the body.

In one or more embodiments of a pipeline strainer according to the various aspects of the present invention, the second end of the straining element is disposed proximate the debris drain.

According to a third aspect of the present invention, the present invention provides a pipeline strainer comprising a body and a straining element. The body comprises an inlet for a fluid, an outlet for the fluid, a cavity inside of the body defined at least in part by an inner surface and connecting the inlet and the outlet, a debris drain, a baffle extending away from the inner surface into the cavity of the body, and an air release valve configured to vent gas from the cavity of the body. The straining element is disposed in the cavity, and includes a first end and a second end opposite the first end. The first end of the straining element is disposed proximate the inlet of the body. The baffle is disposed between the inlet and the outlet of the body. The air release valve is disposed between the baffle and the outlet.

In one or more embodiments of a pipeline strainer according to the various aspects of the present invention, the baffle includes an upstream surface and a downstream surface, and the upstream surface is disposed between the first end of the straining element and the outlet.

In one or more embodiments of a pipeline strainer according to the various aspects of the present invention, the second end of the straining element is disposed proximate the debris drain.

These and other aspects and embodiments of the present invention will be appreciated by those of ordinary skill in the art based upon the following description of the drawings and detailed description of the preferred embodiments.

### BRIEF DESCRIPTION OF THE DRAWINGS

The attached figures in the drawings will make it possible to understand how the invention can be produced. In these figures, similar reference numbers denote similar elements.

FIG. 1 is a side perspective view of a pipeline strainer according to one or more embodiments of the present invention.

FIG. 2 is a cutaway side perspective view of a pipeline strainer according to one or more embodiments of the present invention with a baffle and an air valve.

FIG. 3 is a cutaway side perspective view of a pipeline strainer according to one or more embodiments of the present invention with a baffle.

FIG. 4 is a side cutaway view of a portion of a pipeline strainer according to one or more embodiments of the present invention with a baffle.

FIG. 5 is a side cutaway view of a portion of a pipeline strainer according to one or more embodiments of the present invention with a baffle.

FIG. 6 is a side cutaway view of a portion of a pipeline strainer according to one or more embodiments of the present invention with a baffle.

FIG. 7 is a front view of a baffle that may be used in a pipeline strainer according to one or more embodiments of the present invention.

FIG. 8 is a front view of a baffle that may be used in a pipeline strainer according to one or more embodiments of the present invention.

### DETAILED DESCRIPTION OF THE PREFERRED EMBODIMENTS

As mentioned above, a new pipeline strainer has been invented which includes an air release valve, a baffle, or both. The air release valve may be used to vent entrained gas that have accumulated within the cavity or body of the pipeline strainer. Additionally, the baffle may be used to create an eddy, or low pressure area, in which entrained gas may accumulate within the cavity or body of the pipeline strainer. The accumulated gas can be vented if an air release valve is provided or released when the pipeline strainer is cleaned and opened to the atmosphere.

Accordingly, with reference the attached drawings, one or more embodiments of the present invention will now be described with the understanding that the described embodiments are merely preferred and are not intended to be limiting.

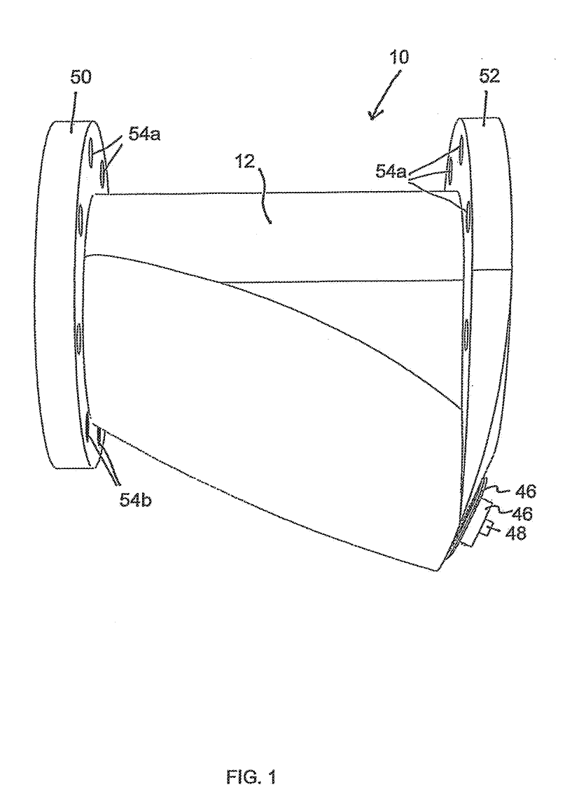

With reference to FIG. 1, a pipeline strainer 10 according to one or more embodiments of the present invention comprises a body 12. The body 12 can be made from a variety of appropriate materials, including, for example, iron, carbon steel, carbon moly, stainless steel, chrome moly, aluminum, bronze, monel, nickel, HASTELLOY® B, HASTELLOY® C, titanium, and plastic.

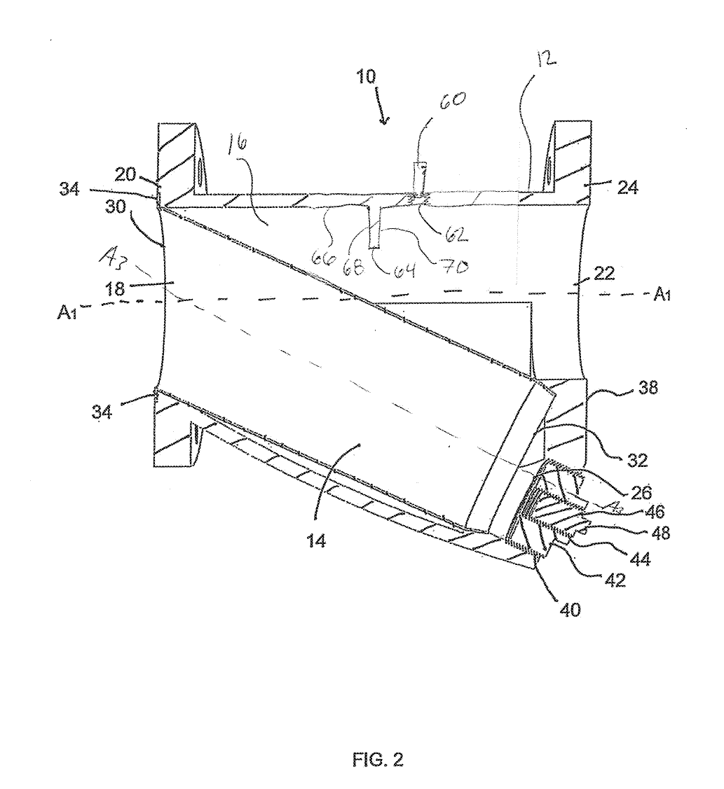

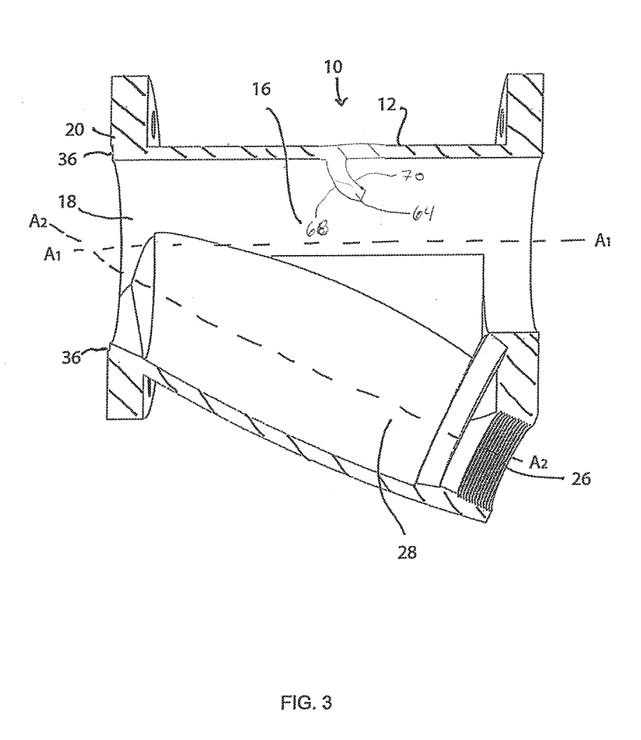

Turning to FIG. 2, the pipeline strainer 10 also includes a straining element 14. The body 12 also includes a cavity 16 disposed inside of the body 12 which houses at least a portion of the straining element 14. The body 12 includes an inlet 18 to the cavity 16 for a fluid disposed at a first end 20 of the body 12. An outlet 22 from the cavity 16 for the fluid is disposed at a second end 24 of the body 12. The inlet 18 and outlet 22 of the body 12 are both generally disposed along an axis A₁. As can be seen best in FIG. 3, the body 12 also includes a debris drain 26 that is disposed in a portion of the cavity 16 that comprises a debris collection chamber 28 that houses the straining element 14.

Returning to FIG. 2, the straining element 14 is disposed in the body 12 and removes debris in the fluid passed through the body 12 from the inlet 18 to the outlet 22. An axis A₃ of the straining element 14 extends from a first end 30 to a second end 32. Preferably, both the first end 30 and the second end 32 are open. The second end 32 is disposed proximate the debris drain 26 of the body 12, when the straining element 14 is inserted therein. In various embodiments, at least the first end 30 of the straining element 14 is planar and lies in a first plane. The second end 32 of the straining element 14 may also be planar and lie in a second plane. In at least one embodiment, the first plane, which includes the first end 30 of the straining element 14, is disposed obliquely to the longitudinal axis A₃ of the straining element 14. The second end 32 of the straining element 14 may be disposed perpendicular to the longitudinal axis A₃ of the straining element 14.

In the depicted embodiment, the pipeline strainer has a Y-shape in which an angle between the axis A₁ of the body 12 and the axis A₃ of the straining element 14 is less than 90°. Preferably, the angle is between 30 to 60°, and most preferably, the angle is less than 30° and greater than 9.5°. For example, preferred angles include may be about 22.0°, 22.5°, 23.0°, 23.5°, 24.0°, 24.5°, 25.0°, 25.5°, 26.0°, 26.5°, 27.0°, 27.5°, 28.0° or 28.5°. By the term “about” with respect to the angle between the axis A₃ of the straining element 14 and the axis A₁ of the body 12, it is intended to mean the stated angle +/−0.3°. Such pipeline strainers are disclosed in U.S. patent application Ser. No. 14/597,634 filed on Jan. 15, 2015, the entirety of which is incorporated herein by reference. However, it is also contemplated that the angle between the axis A₁ of the body 12 and the axis A₃ of the straining element 14 is 90°—in which the pipeline strainer comprises a basket strainer—such as shown in FIG. 4 of U.S. Pat. No. 5,718,822 (the entirety of which is incorporated herein by reference).

Various materials can be used for the straining element 14 including carbon steel, stainless steel, monel, HASTELLOY® B, HASTELLOY® C, alloy 20, nickel, brass, copper, galvanized steel, INCOLOY®, INCONEL®, titanium, aluminum, and plastic, to name a few. The straining element 14 can also be lined with various coatings to minimize corrosion, such as epoxy, asphalt, polytetrafluoroethylene, vinyl, polychlorotrifluoroethene, rubber, neoprene, baked phenolic, and plating with zinc, cadmium, nickel, galvanizing, etc.

One consideration in the selection of a straining element 14 material is the size of the perforations, mesh or wedge wire opening used in the making of the straining element 14 based upon the size and quantity of particles which can pass through downstream equipment without causing damage to the equipment. The use of smaller holes than those actually required, can lead to too-frequent cleaning, excessive pressure drops, and screens constructed of thinner metal which will withstand less pressure differential. Generally, stainless steel perforated metal may be typically obtained in a thickness which is one gage thickness less than the diameter of the punched holes. Carbon steel and brass can be obtained in approximately the same thickness as the hole diameter. A common way to accomplish fine straining in large straining elements 14 is by mesh lining a larger hole, heavier gage perforated plate.

The capacity ratio, or open area ratio (OAR) of the straining element 14 influences such operating characteristics as the length of time it can operate without cleaning and the created pressure loss. The OAR is the relationship between internal cross sectional area (flow area) of the pipe and the open flow area of the material which makes up the straining element 14.

A straining element 14 with at least 100% OAR, or 1-to-1 ratio, would provide an unrestricted flow area equal to that of the pipe while the element was clean. As clogging occurs, however, flow would provide restricted flow, after the element became 50% clogged. A straining element 14 with a 400% OAR is acceptable for general heating and air conditioning service. Additionally, larger OARs would be appropriate for flow in which much debris is expected to be strained or where very viscous fluids are being handled.

When considering the OAR of a straining element 14, there are two accepted methods of analysis used by various specifying agencies and manufacturers. One method maintains a “line of sight” reasoning and uses the multiple of the open areas for elements in series. In this method, a 60% open area material in series with a 40% open area material has a resultant combined open area of 24% (i.e., as in accordance with military standards).

An alternative method allows the open area of the more restrictive element in series to be used. This would be 40% for the example above (i.e. as in accordance with Underwriter Laboratory Standards). The method used influences the estimated operating pressure drop, as well as design decisions such as sizing.

As an example, fuel oils are generally strained to a fine degree to protect small orifices in burner nozzles. This requires a fine woven mesh be used in series with a reinforcing perforated plate. Due to the fact that the perforated plate may have a 50% open area and the mesh 30%, the resultant combined open area may be considered to be only 15% if there is no flow path other than line of sight through the two element in series. This would require a straining element 14 with an OAR of 250%, which would be considered a high capacity, large bodied straining element 14. However, this same straining element 14 using only the perforated plate would have an OAR more than three times as great. Thus, for a given straining element 14, the OAR may be varied by using various perforations or meshes having different open areas.

Most pump installations designed for reasonable velocities will permit approximately a 2-psi drop across the straining element 14. When the straining element 14 becomes clogged, the pressure drop varies with the clogging pattern experienced and the type of the straining element 14 being used. If large amounts of solids are expected, use a straining element 14 with a high net open area. As a straining element 14 becomes clogged to the point where the OAR of the straining element 14 approaches the pipe area, the pressure drop across the straining element 14 increases very rapidly and unpredictably. It is at this point, therefore, that it is recommended the straining element 14 be cleaned, discussed below, otherwise, a large differential pressure will develop. The maximum differential pressure the straining element 14 can withstand varies widely with the straining element 14 type, line size and material used.

As fluids with debris are passed through the straining element 14, the debris is collected and accumulated in the straining element 14. The fluid, having a lower amount of debris, will pass out of the staining element 14. After passing out of the straining element 14 the fluid can exit the body 12 via the outlet 22. However, as indicated above, it may be desirable to remove some of the entrained air from the fluid before it passes out of the pipeline strainer 10.

Accordingly, as shown in FIG. 2, the pipeline strainer 10 includes an air release valve 60. In an exemplary embodiment, a threaded aperture 62 passes through the body 12 and into the cavity 16 and is disposed downstream of the straining element 14. The air release valve 60 is disposed in the threaded aperture 62. Entrained gas may accumulate in the threaded aperture 62 and can be vented to the atmosphere continuously or as needed. This positioning is merely exemplary.

In addition to the air release valve 60, or in the alternative, a baffle 64 (or flow direction vane) is disposed inside of the cavity 16. The baffle 64 will create an eddy in the cavity 16 in which entrained gas may accumulate.

The baffle 64 extends away from an inner surface 66 which defines the cavity 16 and has an upstream surface 68 and a downstream surface 70. The baffle 64 is disposed between the inlet 18 and the outlet 22, and most preferably downstream of the straining element 14 and between the straining element 14 and the outlet 22. By downstream of the straining element 14, it is meant that fluids will not encounter the upstream surface 68 of the baffle 64 until after passing out of the straining element 14. The baffle 64 may include coalescing material or the like (such as a coalescing texture) to enhance the combination of entrained gas. Such coalescing material/texture may be disposed, for example, on the downstream surface 70 of the baffle 64. Exemplary coalescing materials/textures include wire brushes, fibrous materials, or any other materials/textures that can improvable the coalescing ability of the surface 68, 70 of the baffle 64.

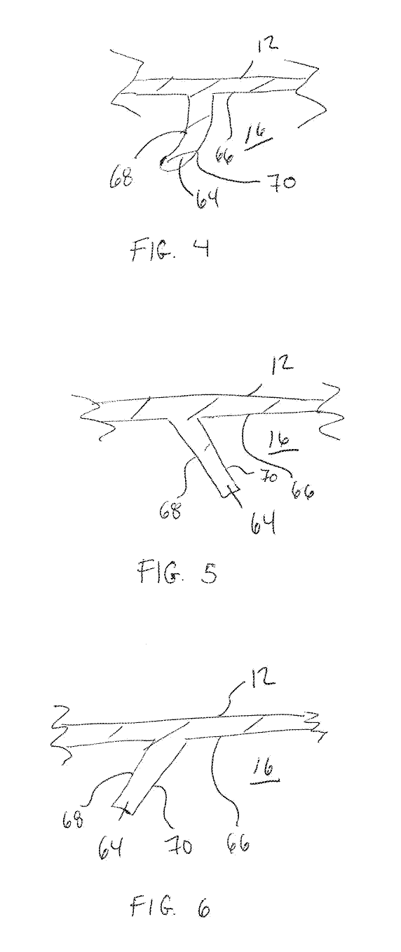

Generally, in a profile view (i.e., a side view), the baffle 64 may have a linear shape (i.e., be flat or planar) as shown in FIGS. 2, 5 and 6. Alternatively, the baffle 64 may have a curvilinear shape as shown in FIGS. 3 and 4. The baffle 64 may extend in directed towards the outlet 22 (FIGS. 3 and 5) or the baffle 64 may extend in directed towards the inlet 18 (FIGS. 4 and 6).

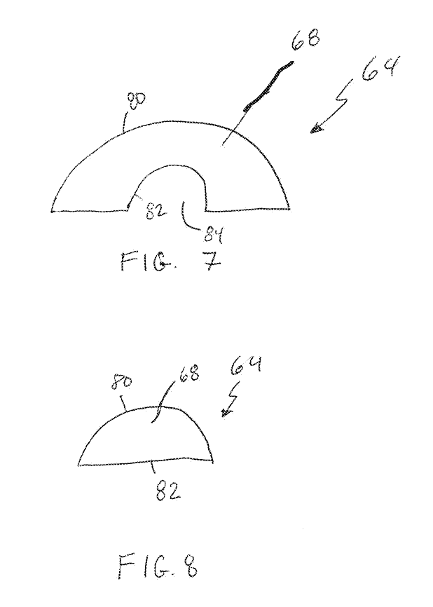

As shown in FIG. 7, the baffle 64, when viewing the upstream surface 68 (or downstream surface 70 (not shown)), may comprise a semi-circular outer edge 80 that generally follows a portion of the inner surface 66 (see FIG. 2) of the cavity 16. In the depicted embodiment an inner edge 82 includes a cutout 84 providing the baffle 64 (when viewed from the front or the back) with an inverted U shape. This is merely a preferred design, and other designs can be utilized, for example, the baffle 64 shown in FIG. 8 in which a cutout is not utilized and the baffle 64, when viewing the upstream surface 68, comprises a hemispherical shape.

If the pipeline strainer includes both the baffle 64 and the air release valve 60, it is preferred that the air release valve 60 is disposed adjacent the baffle 64, most preferably proximate the downstream surface 70 of the baffle 64. Any accumulated gas may be vented from the body 12 through the air release valve 60. If, however, the pipeline strainer 10 does not include the air release valve 60, the gas may accumulate in the eddy, downstream of the baffle 64, and when the fluid flow to the pipeline strainer 10 is stopped or slowed, for example to remove debris from the straining element 14 (discussed below), any accumulated gas may be released to the atmosphere.

As mentioned above, since the straining element 14 will remove (or retain) particulate material in the fluid, the straining element 14 must be periodically cleaned. According to various embodiments of the present invention, and as shown in FIG. 2 the debris drain 26 may comprise a threaded bore 40 and a plug 42. The plug 42 includes an outer circumferential surface that is threaded to engage the threaded bore 40. The plug 42 may be sized to be smaller than the second end 32 of the straining element 14.

In a most preferred embodiment, the plug 42 also includes a threaded bore 44 there though, and a second plug 46. The second plug 46 includes a threaded outer circumferential surface that is threaded so as to engage the threaded bore 44 of the first plug 42. An end 48 of the second plug 46 may be configured to cooperate with a tool, such as a wrench, ratchet, or other similar tool that can be used to rotate the first plug 42 and the second plug 46. The threaded bores 44 and 40 may be oppositely threaded, i.e., one including a right-handed thread and the other including a left-handed thread, however, this is not required. In some embodiments or when in use, the second plug 46 may be replaced with a valve (not shown), that allows debris collected in the straining element 14 to be drained by merely opening the valve. The plug 42, which is larger, can be removed for a visual inspection of the straining element 14 or to allow for removal of larger debris that cannot pass through the valve (or the threaded bore 44).

The use of the threaded bore 40 and plug 42 will also save time when opening and closing the debris drain 26 compared to prior art designs that comprise an end cap with flanges and a plurality of fasteners used to secure the end cap to the pipeline strainer.

Retuning to FIG. 1, as discussed above, the pipeline strainer 10 is typically disposed within conduits or piping. In order to secure the ends 20, 24 of the pipeline strainer 10 to the conduits or other piping, the first end 20 of the pipeline strainer 10 and the second end 24 of the pipeline strainer 10 may each include a flange 50, 52 extending outwardly away therefrom. The flanges 50, 52 may each include a plurality of apertures 54a, 54b, each sized to receive a fastener (not shown), such as a bolt or screw. The apertures 54a, 54b may also be configured to be in alignment with apertures on flanges on the conduits (not shown). In some embodiments of the present invention, at least one aperture 54b in the flanges 50, 52 of the pipeline strainer 10 comprises a threaded bore, and at least one aperture 54a is smooth. By smooth it is meant that the inner surface of the aperture 54a is not engaged by a fastener extending there through. These fasteners are held in place by another item, such as a nut (not shown).

As discussed above, the various embodiments of the present invention provide a pipeline strainer that provides for the ability to accumulate entrained gas, vent entrained gas, or both. This ability will decrease the amount of entrained gas that may be passed to downstream equipment.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A pipeline strainer comprising:
a body comprising an inlet for a fluid, an outlet for the fluid, an aperture extending through the body, a debris drain, a cavity inside of the body connecting the inlet and the outlet and being defined at least in part by an inner surface, and an air release valve disposed in the aperture of the body; and,
a straining element disposed in the cavity, the straining element having a first end and a second end opposite the first end, the first end of the straining element disposed proximate the inlet of the body.

2. The pipeline strainer of claim 1 further comprising:
a baffle extending away from the inner surface into the cavity of the body, wherein the baffle is disposed between the inlet and the outlet.

3. The pipeline strainer of claim 2 wherein the baffle includes an upstream surface and a downstream surface, and wherein the downstream surface is disposed proximate the aperture.

4. The pipeline strainer of claim 3 wherein the downstream surface comprises a coalescing material.

5. The pipeline strainer of claim 2 wherein the baffle has a linear shape in a side profile view.

6. The pipeline strainer of claim 2 wherein the baffle has a curvilinear shape in a side profile view.

7. The pipeline strainer of claim 6 wherein the baffle extends away from the inner surface into the cavity of the body in a direction towards the outlet of the body.

8. The pipeline strainer of claim 2 wherein the baffle extends away from the inner surface into the cavity of the body in a direction towards the inlet of the body.

9. The pipeline strainer of claim 1 wherein the second end of the straining element is disposed proximate the debris drain.

10. A pipeline strainer comprising:
a body comprising an inlet for a fluid, an outlet for the fluid, a cavity inside of the body defined at least in part by an inner surface and connecting the inlet and the outlet, a debris drain, and a baffle extending away from the inner surface into the cavity of the body; and,
a straining element disposed in the cavity, the straining element having a first end and a second end opposite the first end, the first end of the straining element disposed proximate the inlet of the body,
wherein the baffle includes an upstream surface and a downstream surface, and wherein the upstream surface is disposed between the first end of the straining element and the outlet.

11. The pipeline strainer of claim 10 wherein the downstream surface of the baffle comprises a coalescing material.

12. The pipeline strainer of claim 10 wherein the baffle extends away from the inner surface into the cavity of the body in a direction towards the outlet of the body.

13. The pipeline strainer of claim 10 wherein the baffle extends away from the inner surface into the cavity of the body in a direction towards the inlet of the body.

14. The pipeline strainer of claim 10 wherein the baffle has a curvilinear shape in a side profile view.

15. The pipeline strainer of claim 10 wherein the baffle has a linear shape in a side profile view.

16. The pipeline strainer of claim 10 further comprising an air release valve being disposed in the body between the baffle and the outlet and being configured to allow gas to be vented from the cavity of the body.

17. The pipeline strainer of claim 10 wherein the second end of the straining element is disposed proximate the debris drain.

18. A pipeline strainer comprising:
a body comprising an inlet for a fluid, an outlet for the fluid, a cavity inside of the body defined at least in part by an inner surface and connecting the inlet and the outlet, a debris drain, a baffle extending away from the inner surface into the cavity of the body, and an air release valve configured to vent gas from the cavity of the body; and,
a straining element disposed in the cavity, the straining element having a first end and a second end opposite the first end, the first end of the straining element disposed proximate the inlet of the body,
wherein the baffle is disposed between the inlet and the outlet of the body, and wherein the air release valve is disposed between the baffle and the outlet.

19. The pipeline strainer of claim 18 wherein the baffle includes an upstream surface and a downstream surface, and wherein the upstream surface is disposed between the first end of the straining element and the outlet.

20. The pipeline strainer of claim 18 wherein the second end of the straining element is disposed proximate the debris drain.
